(19) United States
(12) Patent Application Publication
(10) Pub. No.: US 2020/0142035 A1
(43) Pub. Date: May 7, 2020

(54) ADAPTIVELY-STEERED OPTICAL DETECTION SYSTEM

(71) Applicant: Analog Devices Global Unlimited Company, Hamilton (BM)

(72) Inventor: Yalcin Alper Eken, Istanbul (TR)

(21) Appl. No.: 16/183,299

(22) Filed: Nov. 7, 2018

(51) Int. Cl. G01S 7/481; G01S 13/93; G01S 7/486

(52) U.S. Cl. CPC G01S 7/4817; G01S 13/931; G01S 2013/9375; G01S 2013/9353; G01S 7/4861

(57) ABSTRACT

An optical detection system, such as for use in a vehicular or “smart car” application, can include a receiver having a steerable field-of-view (FOV). An on-board sensor can provide information indicative that a vehicle housing the sensor is turning, and in response, the optical detection system can orient the steerable field-of-view in a direction of a turn indicated by the on-board sensor. In this manner, a receiver having a limited FOV can be re-directed in a direction of the turn to better capture information about obstacles that may be in or nearby the path of travel of the vehicle.

### FIELD OF THE DISCLOSURE

This document pertains generally, but not by way of limitation, to optical systems, and more particularly, to optical detection using a receiver that has an adjustable field of view, such as for a vehicular application.

### BACKGROUND

Optical systems can be used for a variety of applications such as sensing and detection. An optical detection system, such as a system for providing light detection and ranging (LIDAR), can use various techniques for performing depth or distance estimation, such as to provide an estimate of a range to a target. Such detection techniques can include one or more “time-of-flight” determination techniques or other techniques. For example, a distance to one or more objects in a field of view can be estimated or tracked, such as by determining a time difference between a transmitted light pulse and a received light pulse. More sophisticated techniques can be used such as to track specific identified targets within a field of view of the optical detection system. Generally, an optical detection system can include an illuminator, such as a laser or other optical source, and a receiver. The illuminator provides light to a field of regard, such as using a scanning technique or a “flash” illumination technique. A receiver then detects light that is scattered or reflected from objects within the field of regard. A field observable by the receiver can be referred to as a field-of-view (FOV).

### SUMMARY OF THE DISCLOSURE

As mentioned above, optical detection systems are used in various applications, such as for obstacle detection or ranging. For example, in a “smart car” or autonomous vehicle application, various optical sensors can be used to provide information about the surrounding environment. Forward-looking light detection and ranging (LIDAR) can be used to detect objects such as obstacles in a roadway or other vehicles. As an illustrative example, LIDAR systems can be implemented to detect objects that are nearby the vehicle or even hundreds of meters away from the vehicle, such as using a combination of short-range and long-range optical detection schemes.

The present inventor has recognized, among other things, that a trade-off may exist with respect to usable range, resolution, and field-of-view (FOV) in a LIDAR system. For example, to accurately detect objects from a range of about 150 meters to about 250 meters, a LIDAR receiver may have a field-of-view of about 20 to about 40 degrees, in a horizontal plane, such as using a narrow beam scanned across this relatively narrow range of angles. During cornering, the FOV of the LIDAR receiver may not be aligned with the path of the vehicle. For example, on a curved region of a roadway, the exit-end or other portion of the roadway curve may be outside the FOV of a narrow-FOV LIDAR receiver.

To address such challenges, the present inventor has recognized that an optical receiver (or at least a portion of such receiver such as an input optic) can be automatically oriented in a direction of a turn to enhance detection of obstacles that would otherwise be outside the receiver field-of-view. For example, in a vehicular application, an on-board sensor can be used to detect that a turn has been initiated, and optical receiver can be oriented in a direction indicated by the sensor. Various sensor technologies can be used, such as electromechanical sensors (e.g., sensing a steering input such as steering wheel position), inertial sensors (e.g., including accelerometer or gyroscope devices), or location-based sensors can be used such as relying upon a satellite-based navigation scheme. In an example, a relatively narrower-FOV optical receiver having longer range can be combined with a relatively wider-FOV optical receiver (such as supporting an angular range of 100 degrees, horizontal, or more), where the wider-FOV optical receiver has a comparatively shorter range. The narrower-FOV optical receiver can include a steerable FOV that can be mechanically or electro-optically scanned in response to an indication that the vehicle is turning.

According to various examples described in this document, an optical detection system, such as for use in a vehicular or “smart car” application, can include an optical receiver having a steerable field-of-view (FOV). An on-board sensor can provide information indicative that a vehicle housing the sensor is turning, and in response, the optical detection system can orient the steerable field-of-view in a direction of a turn indicated by the on-board sensor. In this manner, a receiver having a limited FOV can be re-directed in a direction of the turn to better capture information about obstacles that may be in or nearby the path of travel of the vehicle.

In an example, a system, such as an optical detection system included as a portion of a vehicle, includes an on-board optical receiver having a steerable field-of-view (FOV), an on-board sensor configured to provide an indication that a vehicle housing the on-board sensor is turning, and a control circuit coupled to the on-board optical receiver and the on-board sensor, the control circuit configured to adjust at least a portion of an on-board optical receiver to orient the steerable FOV in the direction of a turn indicated by the on-board sensor. After adjustment, the steerable FOV can encompass an angular range that was not encompassed before adjustment.

In an example, an automated technique (e.g., a method), such as a processor-directed method performed by an optical detection system included as a portion of a vehicle, provides enhanced detection performance using an optical receiver having a steerable field-of-view (FOV), the method comprising, using an on-board sensor, receiving an indication that a vehicle housing the on-board sensor is turning, and in response, adjusting at least a portion of an on-board optical receiver to orient the steerable FOV in a direction of a turn indicated by the on-board sensor. After adjustment, the steerable FOV can encompass an angular range that was not encompassed before adjustment.

In an example, the on-board optical receiver comprises a first LIDAR receiver, the steerable FOV comprises a first FOV of the first LIDAR receiver, and the system or technique includes using a second LIDAR receiver having a second FOV, the second FOV wider than the first FOV. Optical detection can be performed using the first and second LIDAR receivers, wherein the first LIDAR receiver provides at least one of enhanced resolution, enhanced range, or an enhanced update rate as compared to the second LIDAR receiver.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a system, such as an optical detection system, comprising an illuminator and an optical detector.

FIG. 2 illustrates generally an example comprising a system, such as included on-board a vehicle, including an optical detection system and at least one on-board sensor.

FIG. 3A illustrates generally an example comprising a vehicle including an optical detection system having an adjustable field-of-view (FOV).

FIG. 3B illustrates generally an example comprising a vehicle including an optical detection system having an adjustable field-of-view (FOV), where the adjustable field-of-view is oriented in a direction of a turn as indicated by an on-board sensor.

FIG. 4 illustrates generally an illustrative example showing two different angular ranges, such as corresponding to respective fields-of-view (FOVs) of optical receivers in different states.

FIG. 5 illustrates generally a technique, such as a method, that can include receiving an indication that a vehicle housing a sensor is turning, and, in response, adjusting at least a portion of an optical receiver to orient a steerable field-of-view (FOV) of the receiving in a direction of a turn indicated by the sensor.

FIG. 6 illustrates a block diagram of an example comprising a machine upon which any one or more of the techniques (e.g., methodologies) discussed herein may be performed.

### DETAILED DESCRIPTION

An optical receiver used for optical detection or ranging can include a steerable field-of-view (FOV). The optical receiver can be mounted on or otherwise housed by a vehicle, such as an automobile, light truck, or semi-tractor, for example. The steerable FOV can be adjusted in response to an on-board sensor housed by the vehicle. The present inventor has recognized, among other things, that a steerable field-of-view, controlled in response to information indicative of a turn, can be used to provide obstacle detection and ranging in situations where the optical detection apparatus would otherwise be blind. The techniques described herein do not require or rely upon high-speed continuously-rotating mechanical scanning, by contrast with other approaches. For example, a relatively longer-range narrow-FOV optical receiver can be automatically scanned slowly in a direction of turn, such as proportionally to information indicative of one or more of steering angle, steering rate, angular position, angular rate, or in response to location-based information such as heading or a rate of heading change. In an example, one or more sensors used to adjust a direction of a headlight beam in response to turning can instead or can also be used to provide information for use in automatically adjusting an optical receiver FOV to orient a steerable FOV of the optical receiver in a direction of the turn.

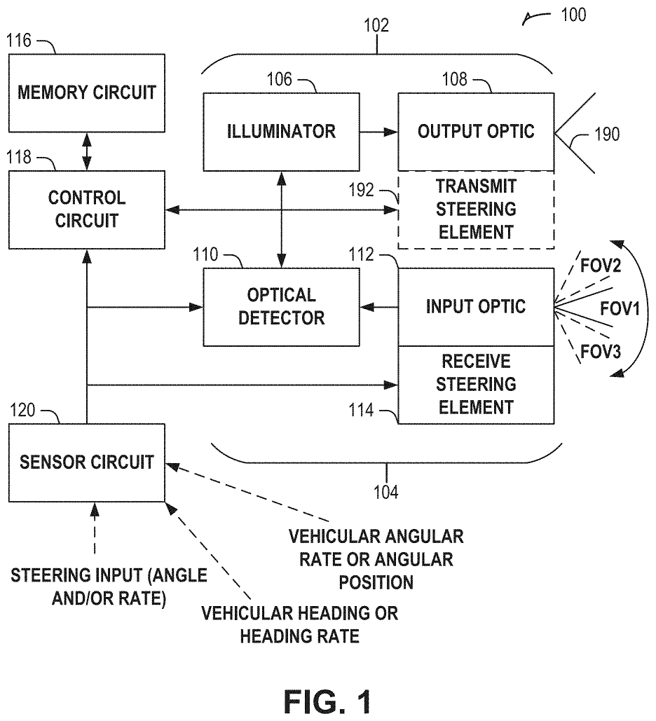

FIG. 1 illustrates generally an example comprising a system, such as an optical detection system 100, comprising an optical transmitter 102 including an illuminator 106 and output optic 108, and an optical receiver comprising an optical detector 110 and an input optic 112. The optical transmitter 102 can include a transmit steering element 192, such as to direct a beam or other output of the optical transmitter 102 to scan across or otherwise illuminate a field of regard 190. In an example, the transmit steering element 192 can include an electro-mechanical actuator configured to rotate or re-orient at least a portion of the optical transmitter 102 assembly, such as the output optic 108. In another example, a liquid crystal waveguide beam-steerer (e.g., a steerable evanescent electro-optical refractor (SEEOR)) or other electro-optical device can be used, such as to scan the transmitted beam in at least one axis without requiring a mechanical steering element. The optical receiver 104 can include an optical detector 110, such as a solid-state photodetector (e.g., a photodiode) or an array of such photodetector elements. The optical detector 110 can include or can be electrically coupled to other circuit elements, such as one or more amplifiers or filters (e.g., one or more transconductance amplifier circuits), conversion circuits (e.g., one or more analog-to-digital converters), or digital signal processing circuitry such as to assist in performing signal conditioning and analysis. An input optic 112 can be optically coupled to the optical detector 110.

The optical detection system 100 can include a control circuit 118, such as an application-specific state machine, processor circuit or microcontroller, or a general-purpose microprocessor circuit, or a programmable logic device such as a field-programmable gate array (FPGA). The control circuit 118 can be coupled to a memory circuit 116. The control circuit can receive information indicative of a turn from a sensor circuit 120 (e.g., a sensor on board a vehicle or otherwise housed by a vehicle, for example). Such information can include sensed information indicative that a turn is being commanded (e.g., information indicative that the vehicle is to be steered in a certain direction), or information indicative that a turn is occurring (e.g., that the vehicle is turning or is being steered in a certain direction).

In one approach, a field-of-view observable by the optical receiver 104 can be fixed (e.g., corresponding to FOV1 as shown in FIG. 1). In another approach, a receive steering element 114 can be used to mechanically or electro-optically adjust a field-of-view observable by the optical receiver 104 (e.g., to provide other FOVs such as FOV2 or FOV3 as shown in FIG. 1). The present inventor has recognized, among other things, that if a first FOV is relatively restricted, such as to an angular range spanning a few degrees or a few tens of degrees in a horizontal plane, then the optical detection system 100 may be blind to objects outside such an angular range. To address such a challenge, the control circuit 118 can be configured to control the receive steering element (e.g., a mechanical actuator) to orient the optical receiver 104 (or a portion of the optical receiver 104 such as the input optic 112) to adjust the FOV being observed by the optical receiver 104, such as “pointing” the FOV in a direction of a turn indicated by the sensor circuit 120. Data indicative of a turn, such as one or more of determined or detected the sensor circuit 120 can include a steering input (such as a steering angle or steering rate from the vehicle steering system). Other forms of data indicative of a turn can include one or more of vehicular angular position or angular rate (e.g., relative to a reference angle), or information derived from location-based services such as indicative of vehicular heading or heading rate (e.g., relative to a reference heading such as magnetic or true north).

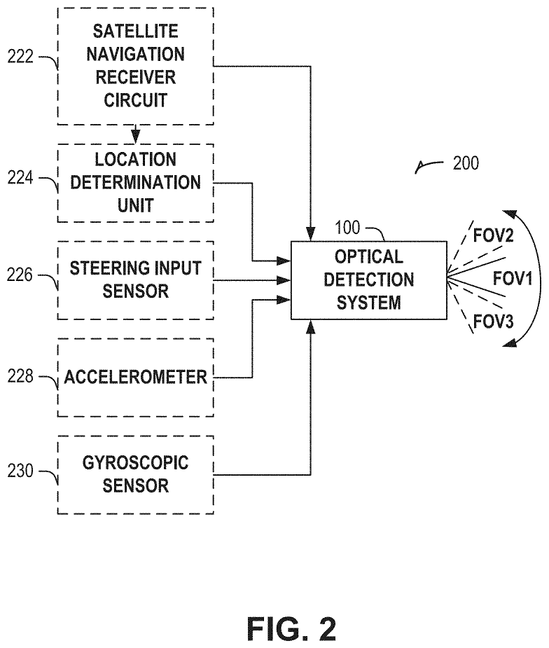

FIG. 2 illustrates generally an example comprising a system 200, such as included on-board a vehicle, including an optical detection system 100 and at least one on-board sensor circuit. As mentioned above, information from one or more on-board sensor circuits can be used to sense and to provide information indicative of a turn. For example, the information provided by a sensor circuit can include information indicative of one or more of a vehicle angular position (e.g., relative to an initial reference angle) or angular rate (e.g., a rate of change of the vehicles angular position with respect to time), or even a rate of the vehicle angular acceleration. Such angular inertial measurement information can be provided by an inertial measurement unit (IMU) comprising one or more of an accelerometer 228 or gyroscopic sensor 230 (e.g., a sold-state accelerometer or gyroscope such as provided by a micro-electromechanical system (MEMS) device).

The sensor circuit can be configured to provide other types of information, such as a steering input or steering angle (e.g., a sensed steering wheel position, or a vehicle tire angular position such as a steering angle sensed by a steering input sensor 226). For example, a steering input sensor 226 can include a Hall-effect sensor, optical encoder, or potentiometer, as illustrative examples.

In yet another example, the sensor circuit can provide information derived from a location determination unit 224. For example, the location determination unit can perform multi-lateration or another technique to ascertain a vehicle position relative to one or more terrestrial or satellite-based references. A change in the vehicle position versus time can be used to determine a vehicle heading or a vehicle heading rate (e.g., a rate of change of a vehicle heading). In an example, a satellite navigation receiver circuit 222 can provide information indicative of received signals from a satellite-based navigation system to the location determination unit 224 or to the optical detection system 100. Such satellite-based systems can include one or more of Global Position System (GPS), Global Navigation Satellite System (GLONASS), or other systems such as GALILEO.

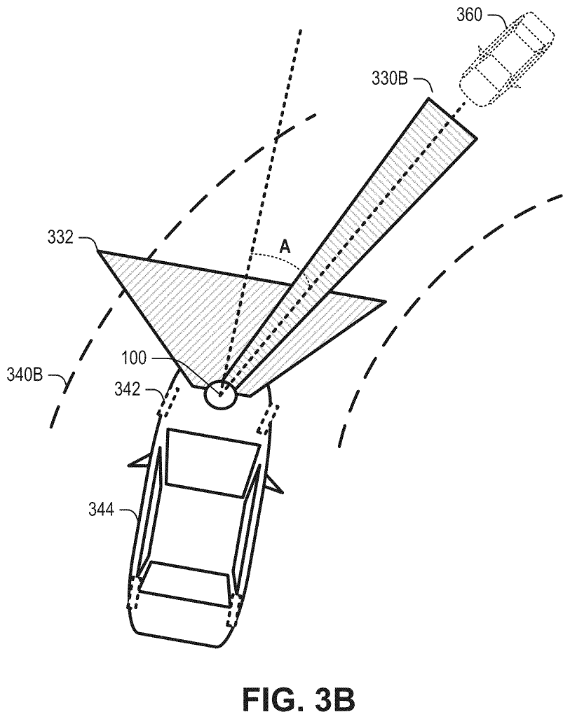

As mentioned above in relation to FIG. 1, the optical detection system 100 can orient or “steer” at least a portion of an optical receiver to align a field-of-view (FOV) of an optical receiver in a direction of a turn indicated by one or more sensor circuits. In this manner, an angular span encompassed by the adjusted FOV of the optical receiver of the optical detection system 100 can capture reflected or scattered light from objects that would have otherwise been outside the FOV before adjustment. For example, in a neutral position, FOV1 can represent a first horizontal angular range corresponding to a state of the optical receiver when the vehicle is not turning. FOV2 can indicate an adjusted FOV corresponding to a left-hand turn and FOV3 can indicate an adjusted FOV corresponding to a right-hand turn. As described herein, such as in relation to FIG. 4, the adjustable FOV can be adjusted in discrete increments in a continuous manner, such as in proportion to information about the turn (e.g., in proportion to angular rate or angular position, for example).

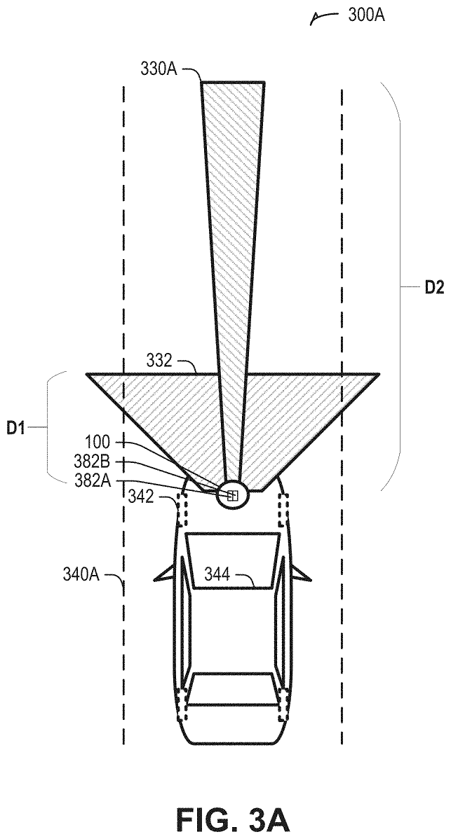

FIG. 3A illustrates generally an example 300A comprising a vehicle 344 including an optical detection system 100 having an adjustable field-of-view (FOV) 330A. Generally, an autonomous vehicle can incorporate a variety of sensors to detect aspects of the surrounding environment. Such sensors can include one or more radar devices, visible or infrared cameras, and other optical detection apparatus such as LIDAR devices. In the examples of FIG. 3A and FIG. 3B, the vehicle 344 can include sensors comprising at least two optical receivers, such as a first LIDAR receiver 382A that provides a first FOV 332, and a second LIDAR receiver that provides the adjustable FOV 330A. A usable range over which objects can be detected can be represented by a distance, “D1,” corresponding to the first FOV 332 and a distance, “D2” corresponding to the adjustable FOV 330A. In FIG. 3A, the distances and angular ranges are not drawn to scale but are shown to illustrate generally that the first FOV encompasses 332 a wider angular range and a shorter range relative to the adjustable FOV 330A. In an illustrative example, the first FOV 332 may be static and may encompass an angular range of 100 degrees in the horizontal plane, or more. A range of the first LIDAR receiver 382A may be limited to less than 100 meters, such as due to constraints such as a trade-off that can exist between frame rate, angular resolution, usable range, or other considerations. In an example, the first LIDAR receiver 382A can include use of a flash illumination scheme, or a scanned transmit technique. The adjustable FOV 330A can be oriented in a direction of a turn, such as encompassing an angular range of about 20-40 degrees, or another angular range, as an illustrative example.

A shape of the adjustable FOV 330A may also be constrained by considerations such as frame rate, receiver sensitivity, transmit power limitations, or scanning limitations related to the illumination scheme. For example, a trade-off can exist between frame rate, angular resolution, and usable range. In order to provide high angular resolution and usable range, the FOV 330A of the longer-range LIDAR receiver (e.g., the second LIDAR receiver 382B) is narrower than the first FOV 332 in the horizontal plane. As an illustrative example, the second LIDAR receiver 382B can use a scanned beam illumination scheme, such as including use of a SEEOR or other electro-optical beam-steerer. In an example, the longer-range LIDAR receiver (e.g., the second LIDAR receiver 382B with the adjustable FOV 330A) can have one or more of a higher angular resolution, a longer range, or a higher frame rate or update rate as compared to the shorter-range LIDAR receiver (e.g., the first LIDAR receiver 382A with the first FOV 332).

In FIG. 3A, the vehicle 344 can be traveling along a relatively straight section of a roadway 340A, and the orientation of the adjustable FOV 330A can be neutral (e.g., pointing “straight ahead” with the wheel 342 position also neutral. By contrast, FIG. 3B illustrates generally an example 300B comprising a vehicle 344 including an optical detection system 100 having an adjustable field-of-view (FOV) 330B, where the adjustable field-of-view 330B is oriented in a direction of a turn as indicated by an on-board sensor (e.g., corresponding to a curve in a roadway 340B).

As mentioned in relation to other examples herein, a sensor circuit can detect information indicative of a turn such as wheel 342 position or other information, and the adjustable FOV 330B can be oriented in a direction of a turn (indicated by the angle, “A” of deflection of the adjustable FOV 330B from the neutral position). In this manner, an object 360, such as another vehicle, that would otherwise be outside the range of a shorter-range FOV 332 is within the FOV of the adjustable FOV 330B. A degree of deflection, A, can be fixed, such as triggered when an angular position, angular rate, or other sensed information indicative of a turn exceeds a specified threshold. Generally, in the approach shown in FIG. 3A and FIG. 3B, a “hybrid” scheme is shown, which can provide a benefit of enhanced angular resolution and range by using a combination of the narrower FOV of the longer-range adjustable FOV330A associated with the second LIDAR receiver 382B and the broader angular range for observing nearby objects using the wider FOV 332 of the shorter-range first LIDAR receiver 382A.

A variety of different scanning approaches can be used in relation to the adjustable FOV 330B. For example, FIG. 4 illustrates generally an illustrative example 400 showing two different angular ranges, R1 and R2, such as encompassing respective fields-of-view (FOVs) of optical receivers in different states. In the examples described in this document, various receiver scanning schemes can be used. For example, when a vehicle is not turning, a static or neutral forward-looking angular range can be used, such as corresponding to a state S1 shown in the example 400 of FIG. 4. The FOV might be automatically adjusted across a limited angular range, R1, of states S1, S2, or S3 even if a turn is not occurring. If information indicative of a turn is received, a greater degree of adjustment can be provided, such as to orient the optical receiver FOV to one or more states S6, S7, or S8 within a second angular range, R2, wherein the second angular range encompasses a range of angles not encompassed by the first angular range R1. A selection of which state, amongst a plurality of discrete FOV orientations, can correspond to a sharpness or degree of the turn, such as proportional to information indicative of steering input, wheel position, angular position, angular rate, heading, or heading rate, as illustrative examples.

The present inventor has recognized, among other things, that a scanning approach to orient the FOV in a direction of a turn need not involve a high rotational velocity or high repetition rate of oscillation, unlike other approaches. For example, a technique to orient the FOV can be similar and can even rely upon sensors used for headlight alignment in response to a turning indication. In this manner, even if a mechanical approach is used (e.g., a mechanical actuator), the angular rate and duty cycle are believed to be lower than a purely rotational (e.g., continuously spinning) scanning approach, leading to enhanced reliability.

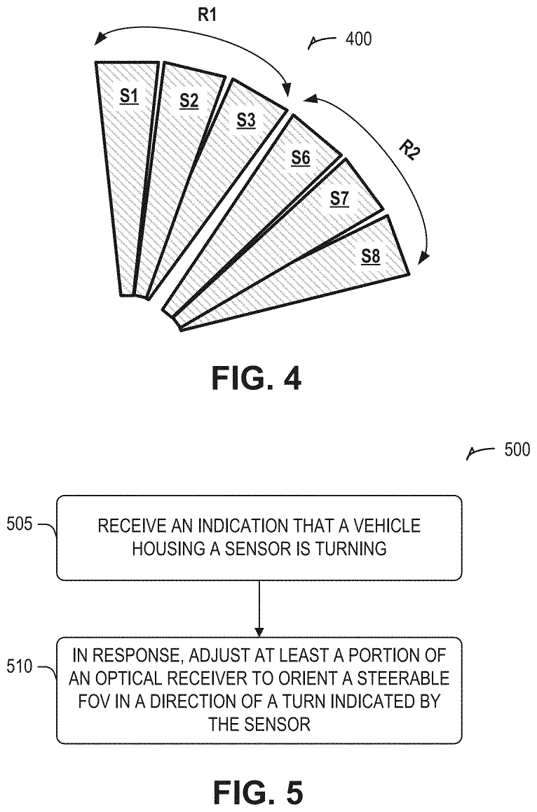

FIG. 5 illustrates generally a technique 500, such as a method, that can include receiving an indication that a vehicle housing a sensor is turning at 505, and, in response, at 510 adjusting at least a portion of an optical receiver to orient a steerable field-of-view (FOV) of the receiving in a direction of a turn indicated by the sensor. For example, at 505, a sensor circuit (or a combination of sensor circuits) can be used to obtain information indicative of a turn, such as shown and described above in relation to the examples of FIG. 1 and FIG. 2. At 510, an optical receiver can be adjusted to orient a steerable FOV in a direction of the turn as indicated by the sensor circuit.

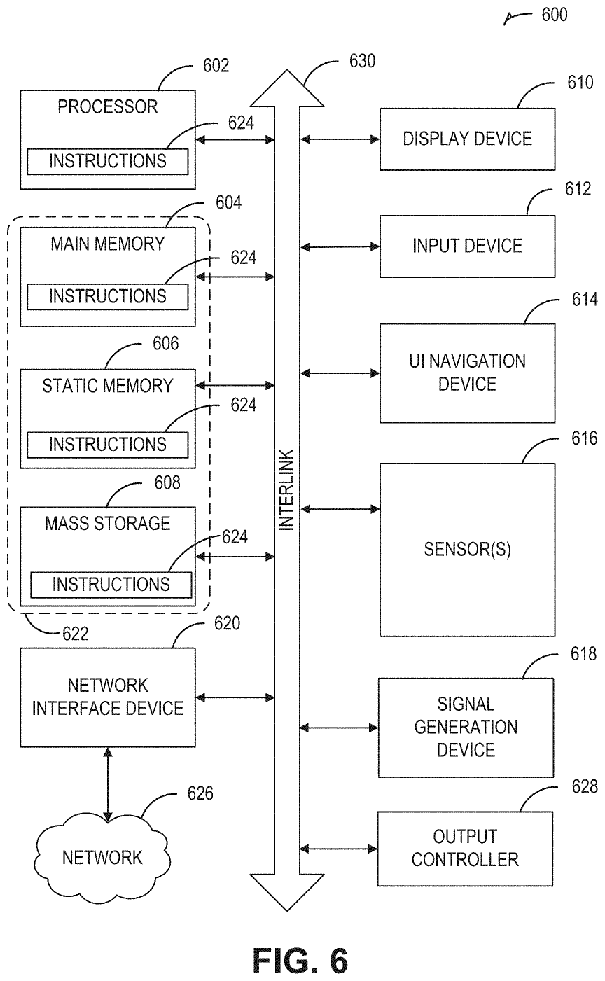

FIG. 6 illustrates a block diagram of an example comprising a machine 600 upon which any one or more of the techniques (e.g., methodologies) discussed herein may be performed. The machine 1600 may be included as a portion of elements shown in the system 100 of FIG. 1. In various examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet device, a personal digital assistant (PDA), a mobile telephone, a web appliance, a network router, switch or bridge, an embedded system such as an electronic control unit (ECU) or an electronic control module (ECM) included as a portion of a vehicle, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. “Circuitry” refers generally a collection of circuits implemented in tangible entities that include hardware (e.g., simple circuits, gates, logic elements, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer readable medium physically modified (e.g., magnetically, electrically, such as via a change in physical state or transformation of another physical characteristic, etc.) to encode instructions of the specific operation.

In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### VARIOUS NOTES

Each of the non-limiting aspects described herein may stand on its own, or may be combined in various permutations or combinations with one or more of the other aspects or other subject matter described in this document.

The above detailed description includes references to the accompanying drawings, which form a part of the detailed description. The drawings show, by way of illustration, specific embodiments in which the invention may be practiced. These embodiments are also referred to generally as “examples.” Such examples may include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

The claimed invention is:

1. A method for providing enhanced detection performance in an optical detection system in a vehicular application, the optical detection system including an optical receiver having a steerable field-of-view (FOV), the method comprising:
using an on-board sensor, receiving an indication that a vehicle housing the on-board sensor is turning; and
in response, adjusting at least a portion of an on-board optical receiver to orient the steerable FOV in a direction of a turn indicated by the on-board sensor;
wherein, after adjustment, the steerable FOV encompasses an angular range that was not encompassed before adjustment.

2. The method of claim 1, wherein the on-board sensor comprises a steering input sensor, and wherein the method includes detecting a steering input using the steering input sensor to provide an indication of at least one of a steering angle or a steering rate, to provide the indication that the vehicle is turning.

3. The method of claim 1, wherein the on-board sensor comprises an inertial sensor, and wherein the method includes detecting at least one of angular position or an angular rate of the vehicle to provide the indication that the vehicle is turning.

4. The method of claim 1, wherein the on-board sensor comprises a location determination unit coupled to a satellite navigation system, wherein the method includes determining at least one of a heading or a heading rate of the vehicle to provide the indication that the vehicle is turning.

5. The method of claim 1, wherein the orienting includes mechanically actuating at least a portion of the optical receiver to orient the steerable FOV in the direction of the turn indicated by the on-board sensor.

6. The method of claim 1, wherein:
the on-board optical receiver comprises a first LIDAR receiver;
the steerable FOV comprises a first FOV of the first LIDAR receiver;
wherein the optical system comprises a second LIDAR receiver having a second FOV, the second FOV wider than the first FOV; and wherein the method comprises performing optical detection using the first and second LIDAR receivers;
wherein the first LIDAR receiver provides at least one of enhanced resolution, enhanced range, or an enhanced update rate as compared to the second LIDAR receiver.

7. A system for providing enhanced optical detection performance in a vehicular application, the system comprising:
an on-board optical receiver having a steerable field-of-view (FOV);
an on-board sensor configured to provide an indication that a vehicle housing the on-board sensor is turning;
a control circuit coupled to the on-board optical receiver and the on-board sensor, the control circuit configured to adjust at least a portion of an on-board optical receiver to orient the steerable FOV in the direction of a turn indicated by the on-board sensor;
wherein, after adjustment, the steerable FOV encompasses an angular range that was not encompassed before adjustment.

8. The system of claim 7, wherein the on-board sensor comprises a steering input sensor configured to detect a steering input and configured to generate an indication of at least one of a steering angle or a steering rate, to provide the indication that the vehicle is turning.

9. The system of claim 7, wherein the on-board sensor comprises an inertial sensor configured to detect at least one of angular position or an angular rate of the vehicle to provide the indication that the vehicle is turning.

10. The system of claim 7, wherein the on-board sensor comprises a location determination unit coupled to a satellite navigation system, the location determination unit configured to detect at least one of a heading or a heading rate of the vehicle to provide the indication that the vehicle is turning.

11. The system of claim 7, comprising a mechanical actuator coupled to at least a portion of the optical receiver and configured to orient the steerable FOV in the direction of the turn indicated by the on-board sensor, in response to a command from the control circuit.

12. The system of claim 7, wherein:
the on-board optical receiver comprises a first LIDAR receiver;
the steerable FOV comprises a first FOV of the first LIDAR receiver; and
the system comprises a second LIDAR receiver having a second FOV, the second FOV wider than the first FOV.

13. The system of claim 12, wherein a range of the first LIDAR receiver is greater than a range of the second LIDAR receiver.

14. The system of claim 12, wherein an angular resolution of the first LIDAR receiver is greater than an angular resolution of the second LIDAR receiver.

15. The system of claim 12, wherein an update rate of the first LIDAR receiver is greater than an update rate of the second LIDAR receiver.

16. The system of claim 12, comprising a first LIDAR transmitter configured to transmit an optical signal for detection by the first LIDAR receiver; and
wherein the control circuit is configured to adjust at least one of a transmitted field or a direction of transmission to orient the optical signal in the direction of the turn.

17. A system for providing enhanced optical detection performance in a vehicular application, the system comprising:
an on-board optical receiver having a steerable field-of-view (FOV);
a means for sensing that a vehicle housing the on-board optical receiver is turning; and
a means for adjusting at least a portion of an on-board optical receiver to orient the steerable FOV in a direction of a turn indicated by the on-board sensor;
wherein, after adjustment, the steerable FOV encompasses an angular range that was not encompassed before adjustment.

18. The system of claim 17, comprising, for use in orienting the steerable FOV, a means of generating an indication of at least one of an angular position of the vehicle, an angular rate of the vehicle, a steering angle, or a steering rate.

19. The system of claim 17, comprising a means for mechanically actuating at least a portion of the optical receiver to orient the steerable FOV in the direction of the turn.

20. The system of claim 17, wherein the on-board optical receiver comprises a first LIDAR receiver;
the steerable FOV comprises a first FOV of the first LIDAR receiver;
the system comprises a second LIDAR receiver having a second FOV, the second FOV wider than the first FOV;
wherein the first LIDAR receiver provides at least one of enhanced resolution, enhanced range, or an enhanced update rate as compared to the second LIDAR receiver.
